(19) United States
(12) Patent Application Publication
(10) Pub. No.: US 2024/0308874 A1
(43) Pub. Date: Sep. 19, 2024

(54) X-PROCESSING OF NMC CATHODE ACTIVE MATERIAL (CAM) FOR LONGER CYCLE LIFE AND STABILITY

(71) Applicant: PRIYADARSHI PANDA, SUNNYVALE, CA (US)

(72) Inventor: PRIYADARSHI PANDA, SUNNYVALE, CA (US)

(21) Appl. No.: 18/401,130

(22) Filed: Dec. 29, 2023

Related U.S. Application Data
(60) Provisional application No. 63/435,805, filed on Dec. 29, 2022.

(51) Int. Cl. C01G 53/00; H01M 4/505; H01M 4/525

(52) U.S. Cl. CPC C01G 53/50; H01M 4/505; H01M 4/525; C01P 2002/54; C01P 2006/40

(57) ABSTRACT

In one aspect, a method for increasing the charge-discharge cycle life and stability/safety of Li-NMC Cathode Active Material (CAM), comprising: processing NMC-111 or NMC-532 or NMC-622 or NMC-811 or NMC-9.5.5 with X elements to increase a cycle life and stability with an X-containing solvent and the CAM matrix followed by a high temperature sintering to embed X-elements in the CAM matrix.

### CLAIM OF PRIORITY

This application claims priority to U.S. Provisional Patent Application No. 63/435,805, filed on 29 Dec. 2022, and titled X-POST PROCESSING OF NMC FOR LONGER CYCLE LIFE. This provisional patent application is hereby incorporated by reference in its entirety.

### BACKGROUND

The state of the art for high volume manufacturing of Li ion cells has primarily used Cathode Active Materials (CAM) which are either NMC (Li(NiₓMn_{y}Co_{z})O₂) or LFP (LiFePO₄). Within the NMC family also known as power/performance chemistry popularly used for electric mobility applications, the development has focused towards higher energy density such as NMC-811 or NMC-9.5.5 which use more Nickel to deliver higher energy density. Higher energy density allows for longer range for instance for electric vehicles (EVs). However, the price to pay for the longer range or higher energy density is in terms of stability to external factors such as overcharge or higher temperature and cycle life (# of charge-discharge cycles before the Li ion cell loses 80% of its initial capacity and has to be discarded). With wider adoption of EVs though, the desire for performance cells (NMC cells) with enhanced stability particularly at higher temperatures and C-rates as well as adoption in cost conscious segments of the market where cycle life (warranty and total cost of ownership) matters is gaining importance. The current work focuses on exploring the space of enhanced stability at higher temperatures and C-rates as well as higher cycle life by modifying the NMC molecules via processing. The work will help proliferate Li ion cells with different characteristics, more suited for mass adoption in hot climates as well as for long lifetime (long warranty) EV for mass adoption.

### SUMMARY OF THE INVENTION

In one aspect, a method for increasing the charge-discharge cycle life and stability of Li-NMC Cathode Active Material (CAM), comprising: processing NMC-111 or NMC-532 or NMC-622 or NMC-811 or NMC-9.5.5 is processed with X elements to increase a cycle life with an X-containing solvent and the CAM matrix followed by a high temperature sintering to embed X-elements in the CAM matrix.

In another aspect, a method for X-processing of NMC that effects both cycle life and stability comprising: utilizing an X as an element for processing NMC; selecting the NMC; mixing the NMC pre-CAM with correct proportions of Ni, Mn and Co per the selected NMC, wherein the mixing is performed in an X ethoxide (X in ethanol solution) at different proportions from 0.2% to 3% at temperatures from 20° C. to 50° C.; mixing a Lithium hydroxide (LiOH) or Li carbonate with the mixed NMC pre-CAM solution in X ethoxide at temperatures from 20° C. to 50° C.; evaporating the Ethanol at 70° C.-100° C. for 15-200 minutes to generate a dry powder; and sintering the dry powder from 400° C.-800° C. for 45-180 minutes before cooling.

It is noted that both aspects of the invention (e.g. pre and post processing) can increase both cycle life as well as stability.

### BRIEF DESCRIPTION OF THE DRAWINGS

FIG. 1 illustrates an example process for increasing the charge-discharge cycle life and stability of Li-NMC Cathode Active Material (CAM), according to some embodiments.

FIG. 2 illustrates another example process, according to some embodiments.

FIG. 3 illustrates the energy density of NMC-622 powder with Vanadium post processing, according to some embodiments.

FIG. 4 illustrates an example graph of a capacity fade for full coin cells charged and discharged from 3-4.2V in CC mode at 1 C rate for both charge and discharge with 5-minute rest time between each charge and discharge, according to some embodiments.

FIG. 5 illustrates a table showing standard C/2 and 1 C capacities at different X levels for prismatic NMC cells as well as N80 (capacities at 20% degradation), according to some embodiments.

FIG. 6 illustrates an example table showing an extrapolated cycle life for long-term cycling at C/2-C/2 in CC mode from 3-4.2V, according to some embodiments.

FIG. 7 illustrates example cycle life curves for long-term cycling at C/2-C/2 in CC mode from 3-4.2V, according to some embodiments.

FIG. 8 illustrates an example extrapolated cycle life for long-term cycling at 1 C-1 C in CC mode from 3-4.2V, according to some embodiments.

FIG. 9 cycle life curves for long-term cycling at 1 C-1 C in CC mode from 3-4.2V, according to some embodiments.

FIG. 10 Capacity and temperature at different C-rates during charging in CC-CV mode with CC from 3-4.2V followed by CV to 0.5 A, according to some embodiments.

FIG. 11 illustrates an example process for X-processing of NMC for longer cycle life and stability, according to some embodiments.

The Figures described above are a representative set and are not an exhaustive with respect to embodying the invention.

### DESCRIPTION

Disclosed are a system and method of an X Processing of NMC for Longer Cycle Life and enhanced stability at high temperatures and C-rates. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Cathode is the electrode from which a conventional current leaves a polarized electrical device.

Lithium nickel manganese cobalt oxides (abbreviated Li-NMC or NMC) are mixed metal oxides of lithium, nickel, manganese, and cobalt. They have the general formula LiNiₓMn_{y}Co_{z}O₂. The most important representatives have a composition with x+y+z that is near 1, with a small amount of lithium on the transition metal site. NMCs can be used on a positive side, which acts as the cathode during charge-discharge.

Prismatic cell can be a cell with the active material chemistry enclosed in a rigid non cylindrical casing made of metal or metal alloys.

Sintering is the process of compacting and forming a solid mass of material by pressure or heat without melting it to the point of liquefaction.

### EXAMPLE METHODS

In one example post-processing of a cathode active powder NMC is performed.

The method can use a post-processing approach to increase the cycle life of any NMC powder (e.g., NMC-111 or 532 or 622 or 811). The method provided herein can be applicable to all types of NMC powders. The method does not perform any modification during the preparation of elements, but it's a processing method to stabilize the applicable molecule(s) and to increase cycle life and stability. The processing can be performed with multiple different kind of elements. Accordingly, it can be X pre/post processing of NMC for longer cycle life. The X can be any element and/or multiple elements. The NMC can be mixed in the X ethoxide. The ethoxide can be evaporated at specified temperature range for a specified period (e.g. see infra ??). Once the ethanol is evaporated, the dry powder is left. That dry powder can be filtered and sintered at a specified temperature (e.g., 400° C. to 800° C., etc.) for a specified time before cooling the powder.

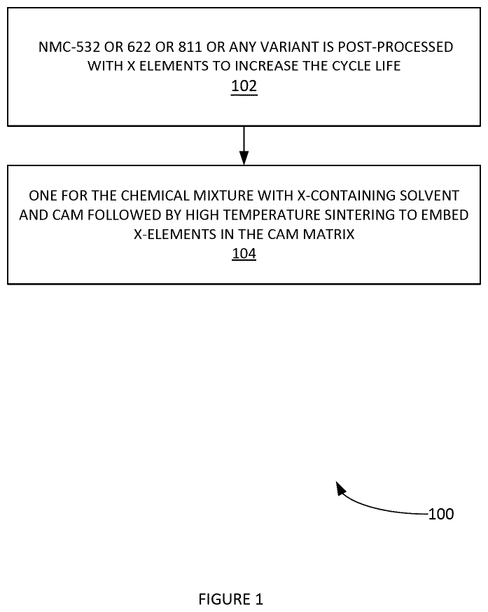

FIG. 1 illustrates an example process 100 for increasing the charge-discharge cycle life of Li-NMC Cathode Active Material (CAM), according to some embodiments. In step 102, NMC-111 or 532 or 622 or 811 or any variant is post-processed with X elements to increase the cycle life and stability. For example, the number of charge-discharge cycles before the energy density degrades by twenty percent (20%) of a starting energy density.

In step 104, the post processing of step 102 can be performed for the chemical mixture with X-containing solvent and the CAM followed by a high temperature sintering to embed X-elements in the CAM matrix.

It is noted that X is an element, for example such as Vanadium, Mo, Nb. NMC can be (e.g. NMC-532, 622, 811 or 90.5.5).

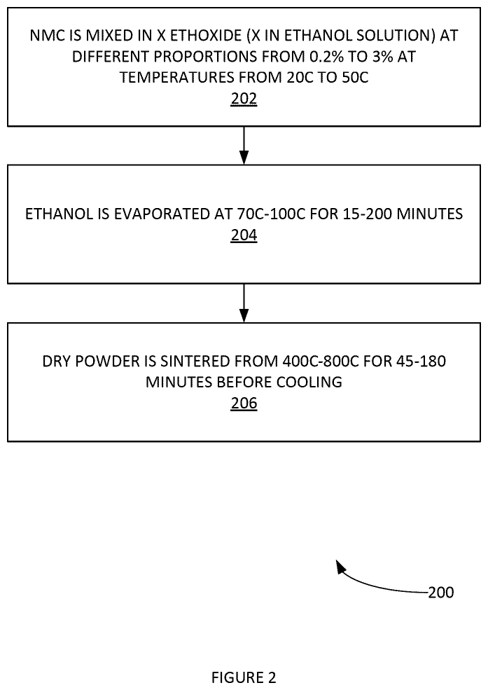

FIG. 2 illustrates another example process 200, according to some embodiments. NMC is mixed in X ethoxide (X in ethanol solution) at different proportions from 0.2% to 3% at temperatures from 20° C. to 50° C. in step 202. In step 204, the ethanol is evaporated at 70 C-100 C for 15-200 minutes. In step 206, the dry powder is sintered from 400 C-800 C for 45-180 minutes before cooling.

In one embodiment of process 200, X is Vanadium. NMC is NMC 622. NMC 622 is mixed with 0.5%, 1.2% and 1.8% solution of vanadium in ethanol at 25 C. Ethanol is evaporated at 85 C in 30 minutes. The dry powder is sintered at 650 C for 80 minutes before cooling down and doing coin cell studies for cycle life. In one example, 0.5% is assigned as Low (L), 1.2% is Medium (M) and 1.8% is High (H).

In one embodiment of process 200, the dry powder can be sintered at any temperature, for example 650° C. for 45 to 180 minutes.

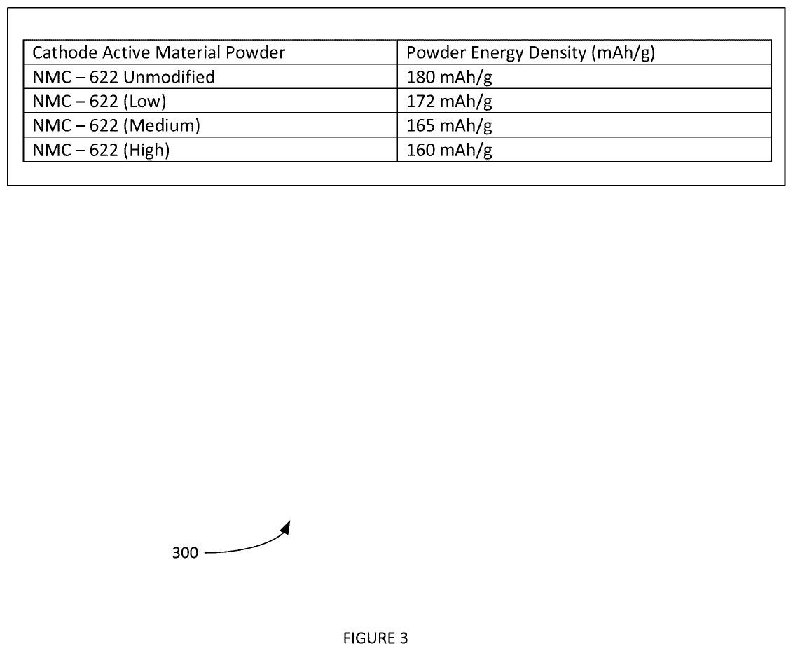

FIG. 3 illustrates the energy density of NMC-622 powder with Vanadium post processing, according to some embodiments. In this example, 0.5% can be assigned as Low (L), 1.2% can be Medium (M) and 1.8% can be High (H). The energy density of NMC-622 powder with Vanadium post processing is in table of FIG. 3.

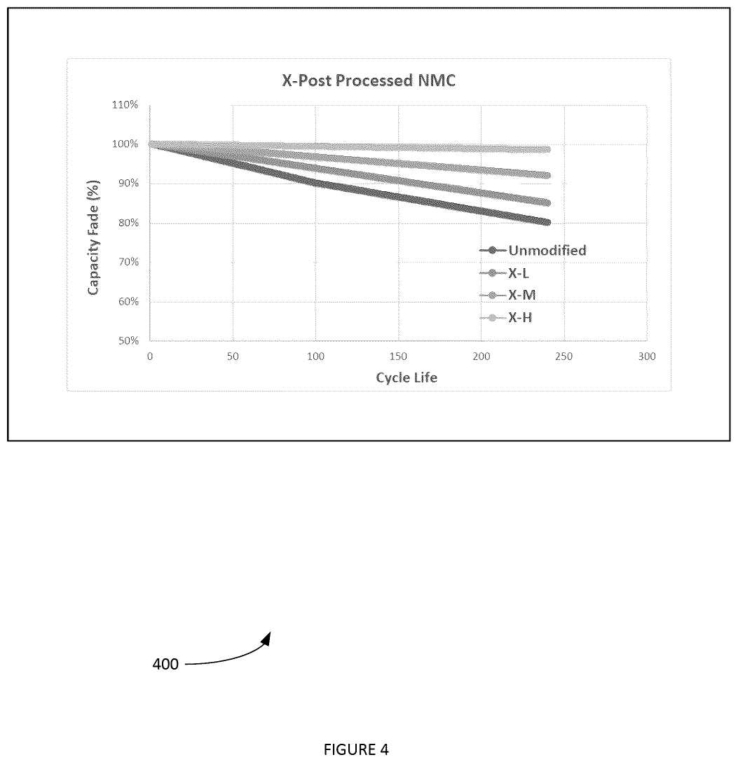

FIG. 4 illustrates an example graph of a capacity fade, according to some embodiments using full coin cells and CC charge-discharge from 3-4.2V at 1 C-1 C with 5 minutes rest between each charge and discharge step. In this example, the capacity fade starts with 100% of the capacity. At 240 cycles, the fundamental energy density fades which is called capacity fade. In the unmodified example, the blue line changes from 100% to 80% at 240 cycles and usually when capacity fades to 80% of starting capacity, the cell can be considered in a dead state.

One line illustrates an X low (e.g. Vanadium low). This shows that the same 240 cycle has only 15% degradation. It goes from 100% to 85% capacity, so the cell can actually go even longer before reaching 80%. In this way, the cell life is increased. Another line shows an X-M example. For example, more vanadium has been added. Here, the fade or the reduction in capacity in the 240 cycles is only 8%. Now, 92% of the capacity is retained. In this way, the cell is longer lasting in terms of the number of cycles.

Yet another line illustrates an X-H example. In this example, one percent of the capacity is lost in 240 cycles. However, the intrinsic powder capacity which we had seen in the table, had gone down from 180 mAh/g to 160 mAh/g. Consequently, there is a trade off right between adding more and more of the molecule X. In one example, there is a loss of fundamental capacity but a gain in stability and cycle life.

The stabilizer molecule and increasing cycle life not only has an advantage of cycle life, but also increases the safety of the molecules. There is increased stabilization as more and more of the X is added (e.g., as more Vanadium is added, etc.). This can make the molecules safer for operations as the cycle life is correlated with safety.

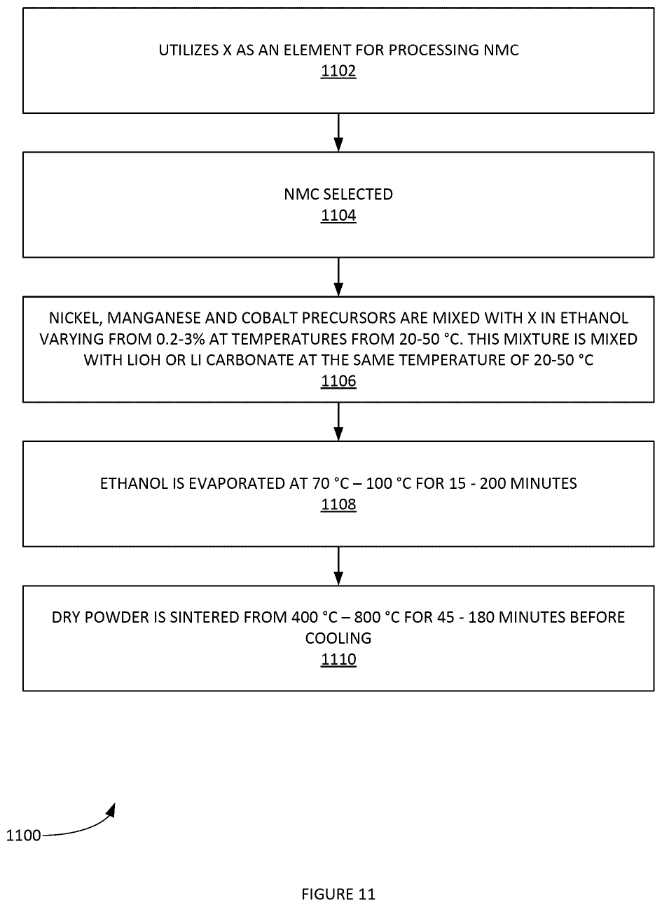

In one example embodiment, X is Vanadium. NMC is NMC 622. Pre-CAM (Pre-Cathode Active Material) can be comprised of six (6) parts of NiOH to 2 parts of MnOH to 2 parts of CoOH is mixed with different concentrations of Vanadium in ethanol and the mix is then mixed with LiOH or Li carbonate at 25° C. The ethanol can then be evaporated at 85° C. in 30 minutes. The dry powder is sintered at 650° C. for 80 minutes before cooling down. The sintered powder is used for doing coin cell studies as well as prismatic cell studies for energy density, cycle life, C-rate, and temperature characteristics. (This is illustrated in FIG. 11)

It is noted that the prismatic cells used had the following characteristics. In further work prismatic cells designed to reach 50 Ah capacity can be tested using the unmodified NMC 622 and X dopant at Low (L), Medium (M) and High (H) concentrations. The areal capacity and N:P (Negative to Positive) ratios can be set to designed values between 7-8 mAh/cm2 for the areal capacity and 1.1-1.2 for the N:P ratio to make the cells.

The four (4) kinds of cells prepared can be tested for C-rate behavior at (C/5-2 C) as well as high temperature (45° C. oven) behavior using CC-CV mode for charge and 3-4.2V as cut-off voltages. Cycle life testing can be performed using CC mode only from 3-4.2V with 5 min rest post each charge and discharge step.

The data suggests that in full prismatic cells, as the X content is increased, the C-rate retention and high Temperature (45° C.) characteristics are improved reasonably. However, there is dramatic improvement in the cycle life at C/2 as well as 1C through the addition of X.

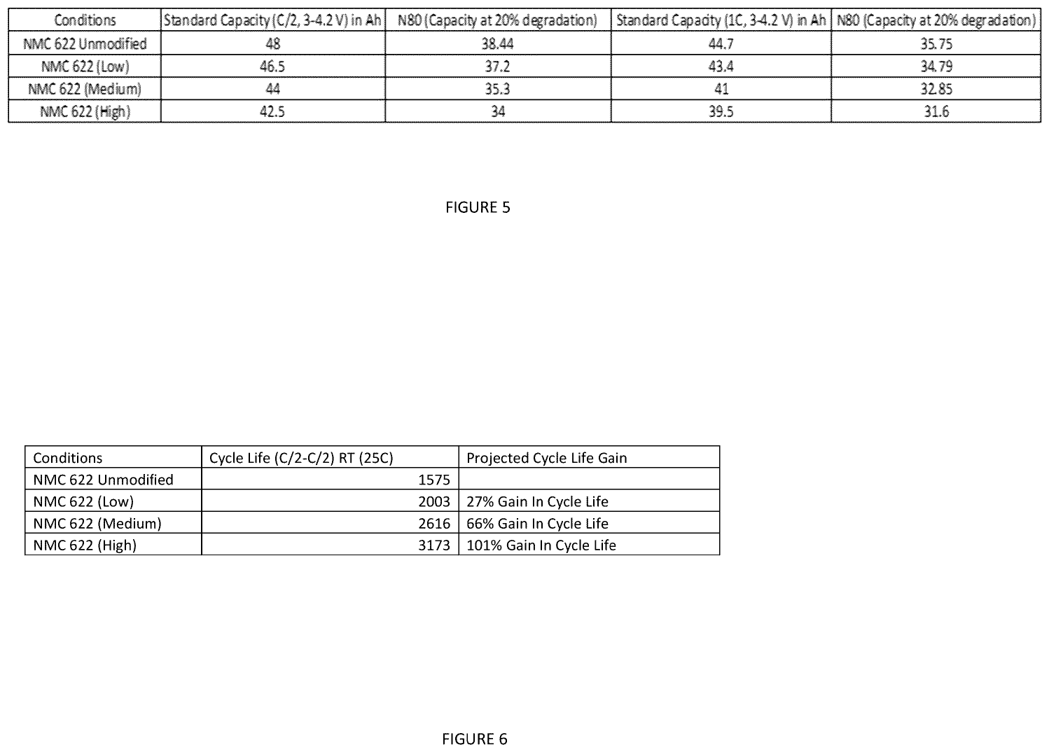

FIG. 5 illustrates a table showing standard C/2 and 1 C capacities at different X levels for prismatic NMC cells as well as N80 (capacities at 20% degradation), according to some embodiments.

FIG. 6 illustrates an example table showing an extrapolated cycle life for long-term cycling at C/2-C/2 in CC mode from 3-4.2V, according to some embodiments. High X processing can lead to almost doubling of the cycle life.

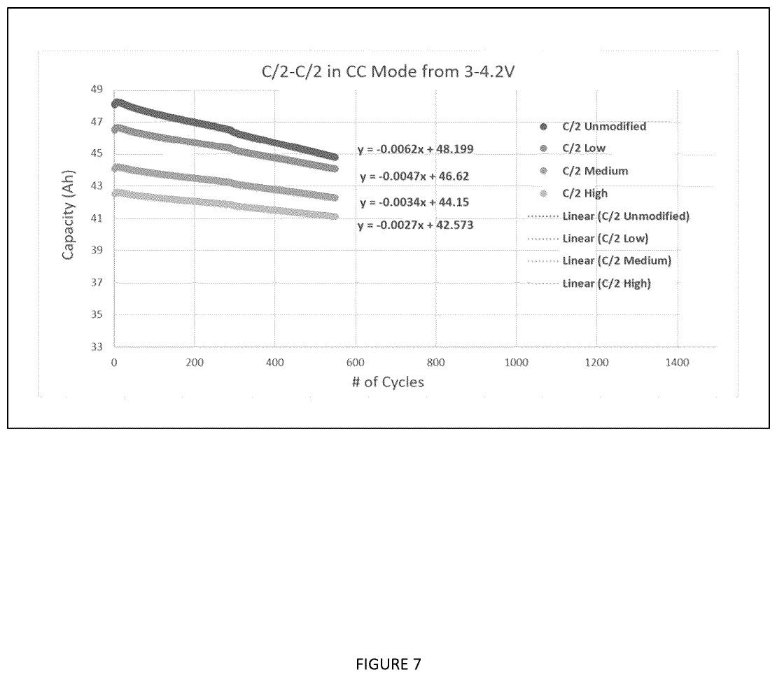

FIG. 7 illustrates example cycle life curves for long-term cycling at C/2-C/2 in CC mode from 3-4.2V, according to some embodiments.

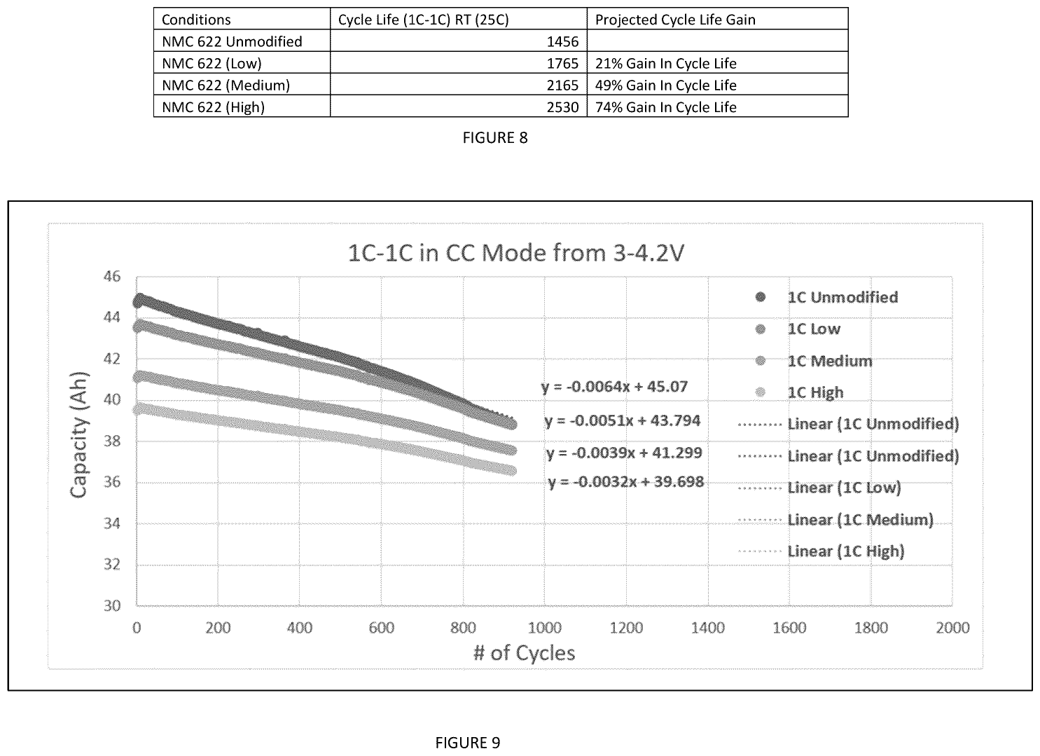

FIG. 8 illustrates an example extrapolated cycle life for long-term cycling at 1 C-1 C in CC mode from 3-4.2V, according to some embodiments. It is noted that high X processing can lead to 74% increase in cycle life.

FIG. 9 illustrates example cycle life curves for long-term cycling at 1 C-1 C in CC mode from 3-4.2V, according to some embodiments.

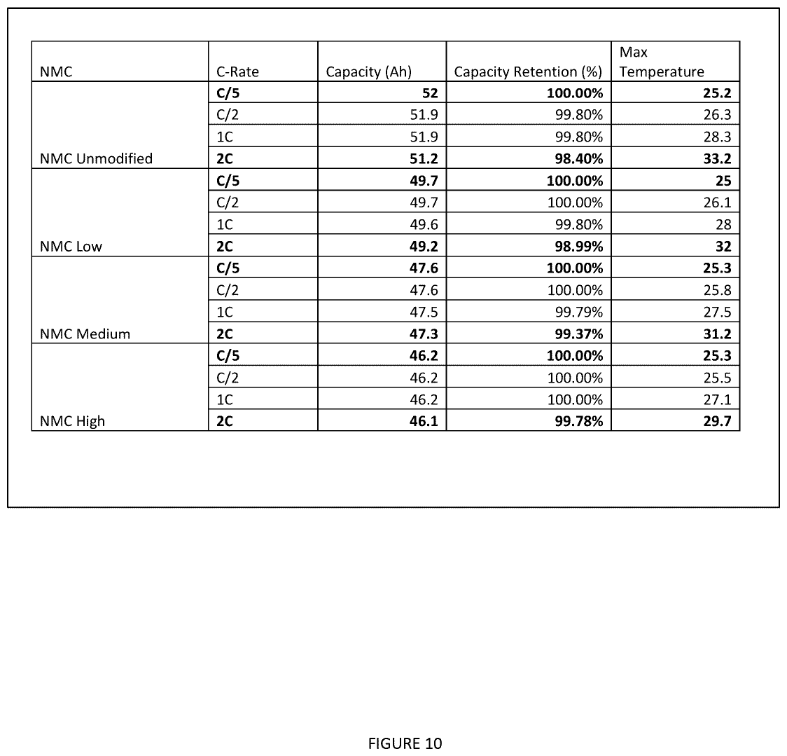

FIG. 10 Charging comparison in CC-CV mode with CC from 3-4.2V followed by CV to 0.5 A, according to some embodiments. Capacity retention and temperature rise at high C-rate shows reasonable improvement with higher X processing.

FIG. 11 illustrates an example process 1100 for X-processing of NMC that effects both cycle life and stability, according to some embodiments. Process 1100 can be a process for pre-processing with X to modify the cycle life and stability of the NMC molecule used as Cathode Active Material (CAM). In step 1102, process 1100 utilizes X as an element for processing NMC. For example, X can be, inter alia: Nb, Mo or Vanadium. In step 1104, the NMC can be selected. The NMC can be, inter alia: (NMC-111, 532, 622, 811 or 9.5.5).

In step 1106, the NMC pre-CAM with correct proportions of Ni, Mn and Co (per NMC chosen in step 1104) is mixed in X ethoxide (e.g. X in ethanol solution) at different proportions from 0.2% to 3% at temperatures from 20° C. to 50° C. Lithium hydroxide (LiOH) of Li carbonate is mixed with the above solution at temperatures from 20° C. to 50° C. Accordingly, in step 1106, Nickel, Manganese and Cobalt precursors (e.g. different ratios based on NMC selected in 1104) are mixed with X in ethanol varying from 0.2-3% at temperatures from 20-50° C. This mixture is mixed with LiOH or Li carbonate at the same temperature of 20-50° C. Ethanol is evaporated at 70° C.-100° C. for 15-200 minutes in step 1108. The result can be a dry powder. The dry powder is sintered from 400° C.-800° C. for 45-180 minutes before cooling in step 1110.

In one embodiment of process 1100, X is Vanadium. NMC is NMC 622. NiOH, MnOH and CoOH in proportions of 6:2:2 is mixed with 0.5%, 1.2% and 1.8% solution of vanadium in ethanol at 25° C. LiOH or Lithium carbonate is then added to the mixture at 25° C. Ethanol is evaporated at 85° C. in 30 minutes. The dry powder is sintered at 650° C. for 80 minutes before cooling down. The sintered powder is used for doing coin cell studies as well as prismatic cell studies for energy density, cycle life, C-rate, and temperature characteristics.

It is noted that either pre or post processing method leads to a final CAM (cathode active material) matrix with X embedded in it which leads to stability and cycle life improvement with some energy density degradation.

It is noted that pre-CAM can be before a process combines with LiOH or Li carbonate. Once the process combines the mixture of NMC in ethanol with the Lithium containing compound and dry it, it becomes a CAM matrix or Cathode active material which is LiNiₓMn_{y}Co_{z}O₂ or a Lithium ternary mixed metal oxide.

It is noted that standard full coin cells can be made with a graphite anode and different variants of NMC-622 (e.g. unmodified, Low, Medium and High of X) as cathode keeping N:P ratio at 1.15. The coin cells were cycled using CC mode from 3-4.2V with 5 minutes rest time between each charge and discharge to study the capacity fades.

### CONCLUSION

Although the present embodiments have been described with reference to specific example embodiments, various modifications and changes can be made to these embodiments without departing from the broader spirit and scope of the various embodiments. Accordingly, the specification and drawings are to be regarded in an illustrative rather than a restrictive sense.

What is claimed by this United States patent:

1. A method for increasing the charge-discharge cycle life of Li-NMC Cathode Active Material (CAM), comprising:
processing NMC-111 or NMC-532 or NMC-622 or NMC-811 or NMC-9.5.5 with X elements to increase a cycle life with an X-containing solvent and the CAM matrix followed by a high temperature sintering to embed X-elements in the CAM matrix.

2. The method of claim 1, wherein any NMC variant is processed with X elements.

3. The method of claim 2, wherein a number of charge-discharge cycles before the energy density degrades by twenty percent (20%) of a starting energy density.

4. The method of claim 1, wherein the X of the X-containing solvent comprises a Vanadium element, an Mo element, or an Nb element.

5. The method of claim 1, wherein the NMC comprises NMC-111, NMC-532, NMC-622, NMC-811 or NMC-9.5.5.

6. The method of claim 1, wherein t the Cathode Active Material (CAM) matrix is reacted with X element containing solvent in a post processing phase.

7. The method of claim 1, wherein the X processing is performed in a pre-processing manner where the X-containing solvent is reacted with a pre-CAM (Pre-Cathode Active Material) and then combined with Li-OH or Lithium carbonate to generate the X processed CAM.

8. The method of claim 1, wherein the chemical mixture with the X-containing solvent and pre-CAM is followed by reaction with LiOH or Li carbonate and finally followed by high temperature sintering to embed X-elements in a CAM matrix.

9. The method of claim 8, wherein the pre-CAM comprises Ni, Mn or a Co containing solution.

10. A method for X-processing of NMC that effects both cycle life and stability comprising:
utilizing an X as an element for processing NMC;
selecting the NMC;
mixing the NMC pre-CAM with correct proportions of Ni, Mn, and Co per the selected NMC, wherein the mixing is performed in an X ethoxide (X in ethanol solution) at different proportions from 0.2% to 3% at temperatures from 20° C. to 50° C.;
mixing a Lithium hydroxide (LiOH) of Li carbonate with the mixed NMC pre-CAM solution at temperatures from 20° C. to 50° C.;
evaporating the Ethanol at 70° C.-100° C. for 15-200 minutes to generate a dry powder; and
sintering the dry powder is sintered from 400° C.-800° C. for 45-180 minutes before cooling.

11. The method of claim 10, wherein the X comprises Nb, Mo or Vanadium.

12. The method of claim 11, wherein the NMC can be (NMC-111, 532, 622, 811 or 9.5.5).

13. The method of claim 10, X is Vanadium.

14. The method of claim 10, wherein the NMC is NMC 622.

15. The method of claim 14, wherein the NMC 622 precursors (NiOH, MnOH, CoOH in proportions of 6:2:2) are mixed with 0.5%, 1.2% or 1.8% solution of vanadium in ethanol at 25° C.

16. The method of claim 15 wherein LiOH or Lithium carbonate is mixed in the solution of ethanol at 25° C.

17. The method of claim 16, wherein the Ethanol is evaporated at 85° C. in 30 minutes.

18. The method of claim 17, wherein the dry powder is sintered at 650° C. for 80 minutes before cooling down.

19. The method of claim 18, wherein the sintered powder is used for performing a coin cell study.

20. The method of claim 18, wherein the sintered powder is used for performing a prismatic cell study for energy density, cycle life, C-rate and temperature characteristics.
